(19) United States
(12) Patent Application Publication
(10) Pub. No.: US 2004/0263483 A1
(43) Pub. Date: Dec. 30, 2004

(54) Sensing device

(76) Inventor: Brian E. Aufderheide, Milwaukee, WI (US)

Correspondence Address: 3M INNOVATIVE PROPERTIES COMPANY, PO BOX 33427, ST. PAUL, MN, 55133-3427, US

(21) Appl. No.: 10/602,423

(22) Filed: Jun. 24, 2003

(51) Int. Cl. G09G 5/00

(52) U.S. Cl. 345/173

(57) ABSTRACT

A sensing system and a method of sensing are disclosed. The system includes a film that self-generates a signal in response to an external agent that is applied to a location on the film. The system further includes a sensor that is configured to detect the self-generated signal at a plurality of positions on the film to determine the location where the external agent is applied to the film.

### FIELD OF THE INVENTION

This invention generally relates to sensing devices. The invention is particularly applicable to such devices incorporating a material that is capable of self-generating an electrical signal in response to a touch implement.

### BACKGROUND

Touch screens allow a user to conveniently interface with an electronic display system by reducing or eliminating the need for a keyboard. For example, a user can carry out a complicated sequence of instructions by simply touching the screen at a location identified by a pre-programmed icon. The on-screen menu may be changed by re-programming the supporting software according to the application. As another example, a touch screen may allow a user to transfer text or drawing to an electronic display device by directly writing or drawing onto the touch screen.

The performance of a touch screen is described in terms of various characteristics of the screen. One such characteristic is optical transmission. Image brightness and contrast increase as a touch screen's optical transmission is improved. High optical transmission is particularly desirable in portable devices where the display is often powered by a battery with limited lifetime. Optical transmission may be optimized by improving optical clarity of different layers in the touch screen, by reducing the number of interfaces, and by reducing reflection at various interfaces.

Another characteristic of a touch screen is the touch implement. Some touch technologies are limited in the type of touch implements that may be used to apply a touch input. For example, capacitive touch sensors generally require a conductive stylus such as a user's finger. Resistive type touch sensors, on the other hand, can generally detect a touch applied by both a conductive touch implement, such as a user's finger, and a non-conductive stylus, such as a user's fingernail. Stylus independence is generally a desirable characteristic in a touch sensor. It is generally desirable that a touch screen register a touch independent of the type of touch implement employed.

Another characteristic of a touch screen is the overall cost. Generally, manufacturing cost increases as the number of layers in a touch screen is increased. Therefore, it is generally desirable that a touch screen include only few layers. Ordinarily, as one screen characteristic is improved, one or more other characteristics often degrade. For example, in an attempt to reduce manufacturing cost, the number of layers in a touch screen may be reduced, potentially compromising other properties of the touch screen such as optical transmission, or stylus independence. As a result, certain tradeoffs are made to best meet the performance criteria for a given application. Therefore, there remains a need for touch screens with improved overall performance.

### SUMMARY OF THE INVENTION

Generally, the present invention relates to sensing devices. The present invention also relates to methods of sensing.

In one aspect of the invention a system includes a film that self-generates a signal in response to an external agent that is applied to a location on the film. The system further includes a sensor that is configured to detect the self-generated signal at a plurality of positions on the film to determine the location where the external agent is applied to the film.

In another aspect of the invention a system includes a film that self-generates a signal in response to an external agent that is applied to a location on the film. The self-generated signal produces at least a first detectable signal at a first position on the film and a second detectable signal at a second position on the film. The system further includes a controller which is adapted to receive at least the first and second detectable signals to determine the location where the external agent is applied to the film.

In another aspect of the invention a touch sensor includes a film that self-generates a signal in response to a touch implement that is applied to a location on the film. The touch location can be determined by detecting the signal at a plurality of positions on the film.

In another aspect of the invention a touch sensor includes a film that self-generates a signal in response to a touch implement that is applied to a location on the film. The touch location can be determined by at least a first sensor detecting a first detectable signal that is produced by the self-generated signal at a first position on the film and a second sensor detecting a second detectable signal that is produced by the self-generated signal at a second position on the film.

In another aspect of the invention a method of determining a touch location includes the step of defining a touch sensitive area that includes a film that self-generates a signal in response to an applied touch input. The method also includes the step of detecting a plurality of detectable signals that are produced in response to the self-generated signal. The method further includes the step of using the plurality of detectable signals to determine the touch location.

### BRIEF DESCRIPTION OF DRAWINGS

The invention may be more completely understood and appreciated in consideration of the following detailed description of various embodiments of the invention in connection with the accompanying drawings, in which:

FIG. 1 illustrates a schematic three dimensional of a system in accordance with an embodiment of the invention;

FIG. 2 illustrates a schematic three dimensional of a system in accordance with another embodiment of the invention;

FIG. 3 illustrates a schematic three dimensional of a touch sensor in accordance with yet another embodiment of the invention;

FIG. 4 illustrates a schematic three dimensional of a touch sensor in accordance with another embodiment of the invention;

FIG. 5 illustrates a schematic side view of a touch sensor in accordance with another embodiment of the invention;

FIG. 6 illustrates a schematic side view of a display system in accordance with another embodiment of the invention;

FIG. 7 illustrates a schematic side view of a piezoelectric film in accordance with another embodiment of the invention; and

FIG. 8 illustrates a schematic side view of a touch sensor in accordance with an embodiment of the invention.

### DETAILED DESCRIPTION

The present invention is generally applicable to sensing devices. The present invention is particularly applicable to touch screens, touch screens used with electronic display systems, and even more particularly to touch screens that are stylus independent, have high optical transmission and low manufacturing cost.

Some touch screens work on the general principle that an otherwise open electrical circuit is closed when a touch is applied. The properties of a signal generated in the closed circuit allows detection of a touch location. Different technologies may be employed to detect a touch location. One such technology is resistive. In a resistive touch, an applied touch brings two otherwise physically separated conductive films into direct physical contact with one another. The physical contact closes an otherwise open electronic circuit, thereby resulting in generation of a resistively coupled electrical signal. The properties of the generated signal allow detection of the touch location.

Capacitive is another technology commonly used to detect the location of a touch. In this case, a signal is generated when a conductive touch applicator, such as a user's finger, is brought sufficiently close to a conductive film to allow capacitive coupling between the two conductors. The two conductors are electrically connected to each other, for example, through the earth ground. Properties of the generated signal allow detection of the touch location. Other viable technologies include surface acoustic wave (SAW), infra-red (IR), and force.

Some known touch technologies utilize a piezoelectric effect in detecting a location of an applied touch. For example, U.S. Pat. No. 3,806,642 discloses applying voltage impulses to a piezoelectric plate to launch traveling piezoelectrically produced mechanical oscillation impulses in a piezoelectric material. The mechanical waves in turn produce a piezoelectric voltage pattern in the piezoelectric plate. A location of a touch applied by an electrically conductive probe is determined when the probe, which is electrically attached to the touch sensor, electrically contacts the surface of the piezoelectric plate at the touch location. As another example, European Patent Application No. 0-753-723-A2 discloses a touch panel that includes a piezoelectric plate polarized in the direction of the plate thickness. The piezoelectric plate is in close proximity to a vibration transmitting plate having a plurality of vibration sensors in predetermined positions. By electrical means, a uniform vibration is induced in the piezoelectric plate. When the piezoelectric plate is pressed, for example, with a pen, the vibration is transmitted to the vibration transmitting plate at the pressed position, and is detected by the vibration sensors. A location of the applied touch is determined from the signals detected by the vibration sensors. Other examples of touch sensors utilizing the piezoelectric effect are disclosed in U.S. Pat. Nos. 4,516,112; 4,866,412; 4,875,378; and 5,673,041. Examples of touch sensors employing a pyroelectric effect are disclosed in U.S. Pat. Nos. 4,307,383 and 4,363,027, and in Kokai Patent Application No. 2001-195190.

The present invention provides a film having a property of self-generating, or equivalently self-producing, a signal in response to an external agent. For example, the signal can be generated by the film in response to the external agent without contribution from additional sources such as an external signal generator, a power supply such as a current or voltage source, or any other additional source that could be instrumental in generating such a signal. Even so, an additional source may be required to determine and/or report information regarding the self-generated signal. According to the present invention, the interaction between the film and the external agent is sufficient to result in a signal generated by the film. This is in contrast to other films, typically used in a touch sensor, such as an electrically conducting film, for example, Indium Tin Oxide (ITO) that do not self-generate a signal in response to an external agent and require a source external to the film in order for a signal to be generated in the film in response to an external agent.

According to the present invention, the signal can be electrical in nature. For example, the signal can be a voltage signal. The voltage signal can, for example, be across the across the thickness of the film. The voltage signal can also be along the plane of the film. Alternatively, the voltage signal can be partially along the thickness of the film and partially along the plane of the film. The self-generated signal can be an electrical current. As another example, the self-generated signal can be a temperature gradient or differential, for example, across the film thickness. In general, the signal can be any information self-generated by the film that can be used to determine the location at which the external agent is applied to the film.

Furthermore, according to the invention, the signal can be generated at or near the location where the external agent is applied to the film. The self-generated signal can also be generated at one or more locations other than the location where the external agent is applied to the film. Such locations can be pre-determined relative to the film geometry or relative to the location where the external agent is applied to the film. For simplicity, and without loss of generality, the location of the self-generated signal is hereinafter referred to as being at the location of the applied external agent, by which it is meant that the two locations may be sufficiently close to each other to meet a desired resolution, and that the two locations need not necessarily coincide. A unique feature of the invention is that the location where the external agent is applied to the film can be determined by detecting the self-generated signal in two or more positions on the film.

Furthermore, according to the invention, the self-generated signal can be used to help determine the location of the self-generated signal which can be the location where the external agent is applied to the film. The self-generated signal can be used by itself or in combination with other signals to determine the location of the signal. The other signals can be signals generated by external signal sources such as a voltage source, or a current source.

According to the invention, the external agent can be an applied touch. The touch may include pressing the film to induce a deformation. The deformation can be reversible, meaning that the film returns to its original form once the applied touch is removed. The touch may include a direct physical touching of the film. Alternatively, the touch can be applied to the film through additional layers or coatings. The touch can also be applied to the film by proximity, for example, by positioning the touch implement sufficiently close to the film. Alternatively, the touch implement can be far from the film. For example, the touch implement can be light from a light source such as a laser light source where the light source is far from the film. In this example, the interaction between the light and the film can cause the film to self-generate a signal.

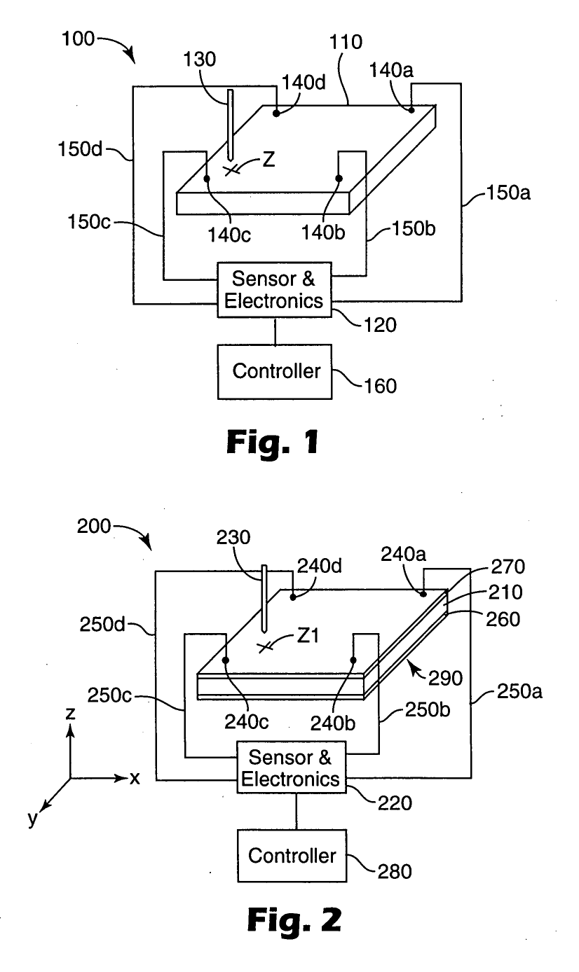

FIG. 1 illustrates a system 100 in accordance with one particular embodiment of the present invention. System 100 includes a film 110 having a characteristic of self-generating a signal at a location where an external agent is applied to the film. According to the present invention, system 100 may include one or more auxiliary signal sources (not shown in FIG. 1) to augment or amplify the signal self-generated by film 110 at the location where the external agent is applied to the film.

In the exemplary system 100, an external agent 130 is applied to film 110 at location Z. The external agent can be, for example, a stylus applying pressure to film 110 at location Z. As another example, the external agent can be a beam of light incident on film 110 at location Z. In general, the external agent includes any external means, in response to which, film 110 self-produces a signal at the point where the external agent is applied to the film.

The self-generated signal can be generated across the thickness of film 110. Alternatively, the self-generated signal can be in the plane of film 110. Alternatively, the self-generated signal can be at least partially across the thickness and at least partially in the plane of film 110. System 100 further includes sensor and electronics 120 for detecting the signal generated at location Z, at pre-determined positions 140a, 140b, 140c, and 140d on the film. Signals detected at positions 140a, 140b, 140c, and 140d are transmitted to sensor and electronics 120 for detection and processing via transmitters 150a, 150b, 150c, and 150d, respectively. Although schematically shown as separated from the film, at least a portion of sensor and electronics 120 can be integrated with film 110.

Sensor and electronics 120 detect the self-generated signal at positions 140a-140d to determine the location where the external agent 130 is applied to film 110. Information generated by sensor and electronics 120 is transmitted to controller 160 to determine the location where the external agent 130 is applied to film 110. System 100 further includes means for transmitting the signal generated at location Z to positions 140a-140d (means not indicated in FIG. 1). Such means can be external to film 110. For example, one or more signal transmitting layers can be coupled to film 110 on one or both sides of film 110 to transmit the self-generated signal. Such transmitting means can be internal or intrinsic to film 110. For example, film 110 can have the additional property of transmitting the self-generated signal to positions 140a-140d. According to FIG. 1, location Z can be determined by detecting the self-generated signal at the four positions 140a-140d in the film. In general, a location of such a self-generated signal can be determined by detecting the self-generated signal at two or more positions or equivalently at a plurality of positions along film 110.

The top and/or bottom surfaces of film 110 can be structured. The structure can, for example, be random or include a regular pattern. For example, a surface can have a random matte finish. The surface can have one or two-dimensional microstructures. A structured surface can reduce glare. A structured surface can also reduce the possibility of slippage when external agent 130 is applied to the film.

External agent 130 may make physical contact to film 110 in order for the film to self-generate a signal in response to the external agent at the contact point. The physical contact may or may not be accompanied with some force or pressure in order to induce a response by the film. Alternatively, the external agent 130 can be at close proximity to film 110 in order to induce a response by the film. In some other instances, the external agent can induce a response in film 110 where the response may be substantially insensitive to the separation between the film and the external agent. In some other configurations, the external agent may, directly or indirectly, apply pressure or force to the film to induce a response in the film. For example, the external agent may contact one or more layers positioned between film 110 and the external agent. Such layers include coatings, substrates, protective layers, and the like.

The signal self-generated by the film can be a voltage, a current, a temperature, a wave or any other signal that film 110 may be capable of self-generating in response to an external agent. Signal transmitters 150a-150d are any suitable means of transmitting signals from positions 140a-140d to sensor and electronics 120. For example, if the self-generated signal is a voltage, transmitters 150a-150d can be electrically conductive electrodes or wires. Although transmitters 150a-150d are displayed as being separate from film 110, at least a portion of the transmitters can be formed on film 110 in a suitable pattern.

The system 100 of FIG. 1 may be optically transmissive or opaque. Furthermore, the system may be rigid or flexible, flat or curved. System 100 may include other components not shown in FIG. 1. For example, system 100 can include additional layers disposed on one or both sides of film 110. Although in FIG. 1, sensor and electronics 120 and controller 160 are shown as separate units, it will be appreciated that in some applications sensor, electronics and controller can form a single unit where means for detecting the location of the applied external agent may not be easily compartmentalized as a sensor component, an electronics component, and a controller component. It will be appreciated that system 100 of FIG. 1 can be employed in a touch sensor to detect a location of an applied touch.

FIG. 2 illustrates a schematic of a system 200 in accordance with another embodiment of the present invention. System 200 includes a film 210 having a characteristic of self-generating a signal at a location where an external agent is applied to the film. External agent 230 is applied to film 210 at location Z1 and induces a self-generated signal in film 210 at the same location. Film 210 is disposed between a top signal transmitting layer 270 and a bottom signal transmitting layer 260. Layers 260 and 270 transmit the signal self-generated at location Z1 to positions 240a-240d where the transmitted signals are detectable. Transmitters 250a-250d transmit the detectable signals from corresponding locations 240a-240d to sensor and electronics 220 to determine the location Z1. According to FIG. 2, two transmitting layers 260 and 270 are used to transmit the self-generated signal from location Z1 to positions 240a-240d. In some instances, a single signal transmitting layer may be used, for example, the top signal transmitting layer 270 or the bottom signal transmitting layer 260. Furthermore, although FIG. 2 shows four positions 240a-240d from which signals are transmitted to sensor and electronics 220, in general at least two such positions can be used to determine the location Z1. Information generated by sensor and electronics 220 can be further sent to controller 280. Controller 280 is coupled to sensor 220 and uses the information it receives to determine the location where the external agent 230 is applied to film 210.

In accordance with one particular aspect of the present invention, system 200 can be a touch sensing device. In this case, the external agent 230 can be a touch implement applying an input touch to the touch panel 290 at location Z1. Film 210 has a property of self-generating a signal at location Z1 in response to the touch implement 230. For example, film 210 can be a piezoelectric material. In general, piezoelectricity refers to an electric polarization produced in a material and by the material in response to a mechanical strain. A piezoelectric material has a property of self-generating a mechanical strain in response to an electrical polarization. Either one of these effects may be employed in system 200. In the case of a piezoelectric film 210, a touch implement that applies sufficient force or pressure to film 210 at location Z1 induces a voltage signal, self-generated by film 210 at Z1 and across the thickness of film 210. According to this particular aspect of the invention, film 210 is disposed between electrically conductive layers 260 and 270. Layers 260 and 270 transmit the voltage signal self-generated at Z1 to the four positions 240a-240d where the transmitted signals are detectable. Optionally, conductive layer 260 may be maintained at a constant potential, for example, the system ground.

Layer 260 and/or 270 can be electrically continuous or be made of discrete components. An electrically continuous electrode can cover the entire film 210, the entire film 210 that is in the touch sensitive area, or a portion of the film in the touch sensitive area. Transmitters 250a-250d can be electrically conductive electrodes or wires transmitting signals from positions 240a-240d to the sensor and electronics 220 to determine the location Z1. Information generated by sensor and electronics 220 can be further transmitted to controller 280 to determine the location Z1. The detectable signals transmitted from positions 240a-240d to sensor 220 can be voltages, currents, or other detectable signals.

Sensor and electronics 220 can include a plurality of sensors. For example, sensor 220 can include a first sensor to detect the detectable signal at the first position 240a, a second sensor to detect the detectable signal at the second position 240b, a third sensor to detect the detectable signal at the third position 240c, and a fourth sensor to detect the detectable signal at the fourth position 240d. The touch location, Z1, is determined by the four detectable signals detected by the four sensors.

The magnitude of the signal self-generated by film 210 in response to a touch implement can be a function of the pressure or the force applied to the film. For example, the self-generated signal intensity can increase as the amount of force applied to the film is increased. Such property can provide means for z-axis control, where the response by system 200 can change depending on the amount of force applied to the film.

Film 210 can self-generate an electrical signal in response to an applied touch during touch down, that is while the touch applies positive force or pressure to film 210. Such a self-generated signal can be referred to as the “touch-down signal.” Film 210 can also self-generate an electrical signal in response to an applied touch during touch up (or lift off), that is while the touch is removed, thereby reducing or terminating the force or pressure previously applied to film 210 during touch down. Such a self-generated signal can be referred to as the “touch-up signal.” Either touch-down signal, or touch-up signal or both can be detected to determine the touch location. Detecting both signals can improve the accuracy of determining the touch location. Furthermore, detecting a touch-up signal can provide means for differentiating a single touch from a touch and drag where, for example, a stylus is applied to the touch sensor and is dragged on the sensor in order to, for example, draw a line on the touch sensor.

Furthermore, the magnitudes of detectable signals detected at locations 240a-240d can provide information regarding the magnitude of the force applied to the film at the touch location. Such information can be used to determine or modify the appropriate response by the touch sensor. For example, where the touch location is designed to control a sound volume, the amount of applied force can be used to determine the appropriate volume level. Alternatively, the volume level can be determined by monitoring the time interval between the times when the touch-down and touch-up signals are self-generated. For example, the longer the time interval, the higher can be the volume level set by the touch sensor.

The top surface of the touch panel can be textured or structured. As discussed above, a structured surface can reduce glare. Furthermore, a textured or structured surface can provide additional information in a self-generated signal in response to a touch implement. For example, dragging a stylus over a textured surface may produce variations in the force or pressure applied to the surface, thereby resulting in variations in the self-generated signal. Such signal variation can, for example, be used to determine the touch location.

Exemplary inorganic piezoelectric materials include lead zirconate titanate (PZT), barium titanate, zinc oxide, quartz, lead lanthanum zirconate titanate (PLZT), lead lanthanum titanate (PLT), lead titanate PT, and combination or composites of different inorganic piezoelectric materials.

Examples of polymeric piezoelectric materials include Polyvinyldene Fluoride (PVDF or PVF2), PVDF co-polymers including P(VDF-TrFE) and P(VDF-TeFE), polyparaxylene, poly-bischloromethyyuloxetane (Penton), aromatic polyimides, polysulfone, polyvinyl fluoride, synthetic polypeptide, cyanoethul cellulose, polyvinylidene fluoride/polymethyl methacrylate blend, polyvinylidene fluoride/polymethyl acrylate blend, polyvinylidene fluoride/polyethyl methacrylate blend, polyvinylidene fluoride/polyviny acetate blend, polyvinylidene fluoride/polyN,N-dimethyl acrylamid blend, vinylidene cyanide/vinylacetate copolymer, nylon, polyvinyl chloride (PVC), polyvinylidene cyanide, vinylidene cyanide/acrylonitrile copolymer, vinylidene cyanide/vinylidene chloride copolymer, vinylidene cyanide/styrene copolymer, vinylidene cyanide/methyl methacrylate copolymer, vinylidene cyanide/vinylbenzoate copolymer, vinylidene cyanide/vinyl chloride copolymer, vinylidene cyanide/acrylic acid copolymer.

Examples of other piezoelectric materials include composites of a polymeric piezoelectric material and inorganic piezoelectric material or ceramic, such as a composite of lead zirconate titanate (PZT) and polyvinylidene fluoride (PVDF).

Alternatively, film 210 can be a pyroelectric material. In general, pyroelectricity refers to an electric polarization self-produced in a material and by the material in response to thermal absorption. For a pyroelectric film 210, a touch implement can generate a temperature gradient or differential in film 210 at Z1, the touch location. The temperature gradient can, for example, be generated across the film thickness. Touch implement 230 can, for example, be an infrared transmitting stylus, where the infrared beam is absorbed by film 210 at location Z1, thereby creating a temperature gradient or differential. Alternatively, the touch implement 230 can emit electromagnetic radiation at one or more wavelengths or a range of wavelengths at which film 210 is sufficiently absorbing to self-generate a signal in the form of a temperature gradient or differential. The temperature gradient can, for example, induce a voltage signal, self-generated by film 210, at Z1. Similar to the discussion above, electrically conductive layers 260 and 270 can transmit the generated signal to the four positions 240a-240d. Detectable signals at 240a-240d are detected by sensor 220 and controller 280. Location Z1 is determined by sensor and electronics 220 and controller 280 based on the four detectable signals detected.

Conductive layers 260 and 270 preferably have uniform conductivity. In the case of an electrically conductive layer, the sheet resistance of the layer is preferably uniform to within 10%, meaning that the maximum deviation from an average sheet resistance over a distance of 2.5 centimeters is no more than 10%. More preferably, the sheet resistance is uniform to within 2%, even more preferably to within 0.5%, and still even more preferably to within 0.2%.

Conductive layers 260 and 270 may be a metal, semiconductor, doped semiconductor, semi-metal, metal oxide, an organic conductor, a conductive polymer, and the like. Exemplary metal conductors include gold, copper, silver, and the like. Exemplary inorganic materials include transparent conductive oxides, for example indium tin oxide (ITO), fluorine doped tin oxide, antimony tin oxide (ATO), and the like. Exemplary organic materials include conductive organic metallic compounds as well as conductive polymers such as polypyrrole, polyaniline, polyacetylene, and polythiophene, such as those disclosed in European Patent Publication EP-1-172-831-A2. Electrically conductive layers 260 and 270 may be electrically continuous across the entire film 210, across the film in the touch sensitive area of the touch sensor, or across a portion of the touch sensitive area. Furthermore, electrically conductive layers 260 and 270 can be made up of discrete electrically conductive segments that are electrically isolated from each other.

According to the discussion above, film 210 can include a pyroelectric or a piezoelectric material. In general, film 210 can include any material that self-generates a signal in response to a touch implement at a location of a touch. For example, other materials suitable for use in film 210 include thermoelectric and ferroelectric materials. In general, film 210 can include a transducer.

The touch sensor 200 of FIG. 2 may be optically transmissive or opaque. Furthermore, the touch sensor may be rigid or flexible, flat or curved.

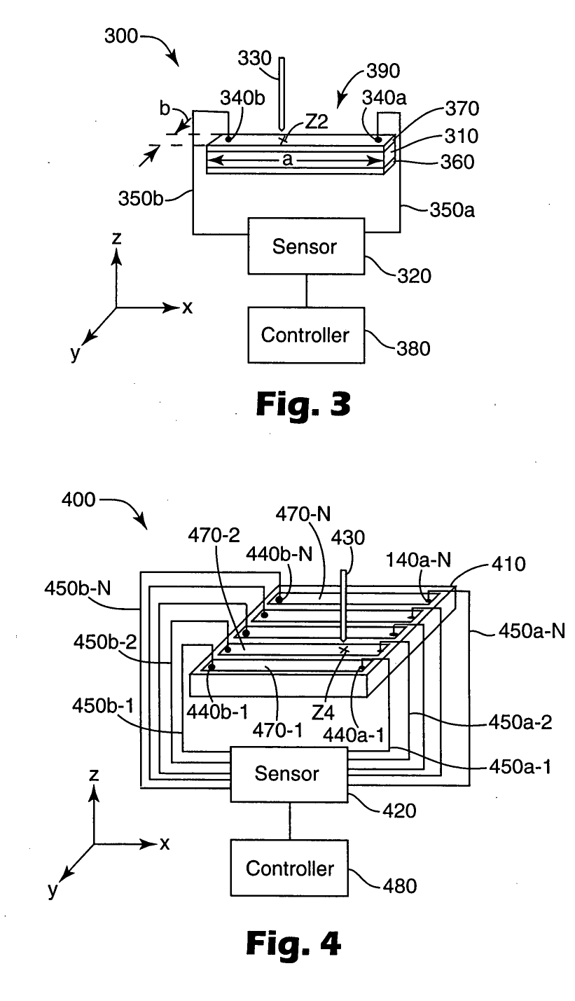

FIG. 2 illustrates determining a location of an applied touch by detecting a self-generated signal at four locations. In general, according to the present invention, a location of an applied touch is determined by detecting a self-generated signal at two or more positions or equivalently, at a plurality of positions on the film. An example where a location of touch is determined by detecting a self-generated signal at two positions is described in reference to FIG. 3.

FIG. 3 illustrates a touch sensor 300 in accordance with one particular aspect of the invention. Touch sensor 300 includes touch panel 390, sensor 320 and controller 380. Touch panel 390 includes a piezoelectric film 310 that, in response to a sufficient force or pressure from a touch implement 330 applied to film 310 at location Z2, self-generates a voltage signal at Z2. Although the particular embodiment shown in FIG. 3 is described with film 310 having piezoelectric properties, the invention is not to be limited to piezoelectric films. Film 310 may include materials having other suitable properties such as pyroelectricity as discussed above.

Referring back to FIG. 3, piezoelectric film 310 is disposed between a top electrically conductive layer 370 and a bottom electrically conductive layer 360 where each layer is electrically continuous, for example across the entire touch sensitive area, or made up of discrete segments electrically isolated from each other. According to this aspect of the invention, dimension “b”, along the y-axis, of the touch panel 390 is sufficiently small, for example given the desirable and/or available touch resolution or accuracy, that a location of an applied touch is adequately determined by determining the x-coordinate of the touch location, along the “a” dimension of the touch panel. Touch implement 330 applies pressure or strain to the touch panel at location Z2. In response to the pressure, piezoelectric film 310 self-produces a voltage signal at location Z2. The signal can, for example, be self-generated across the thickness of the film along the z-axis. The self-generated voltage is transmitted to the two positions 340a and 340b via electrically conductive layers 370 and 360. In some applications, conductive layer 360, or alternatively conductive layer 370 can be maintained at a fixed potential, for example the system ground potential.

Detectable voltage signals at positions 340a and 340b are detected by sensor 320 through electrodes 350a and 350b, respectively. Sensor 320 can determine the x-coordinate of location Z2. The information generated by sensor 320 can further be transmitted to controller 380 for further processing and to determine the touch location. The x-coordinate of location Z2 can be determined based on detectable voltage signals detected by sensor 320 and controller 380. For example, location Z2 can be determined by comparing the relative magnitudes of the two signals detected. As discussed above, signals detected at locations 340a and 340b can be voltage, current, or any other suitable signal that can be used to determine the touch location. FIG. 3 illustrates a one dimensional touch sensor, in the sense that by virtue of dimension “b” being sufficiently small, a determination of the x-coordinate of an applied touch adequately establishes the touch location. Alternatively, touch sensor 300 may include a series of strips as illustrated in FIG. 4.

FIG. 4 illustrates a three-dimensional schematic of a touch sensor 400 in accordance to one particular embodiment of the present invention. Touch sensor 400 includes a piezoelectric film 410 for the sake of illustration, although film 410 can include any material that has a property of self-generating a signal in response to an applied touch. N electrode strips 470-1 through 470-N are disposed on film 410. Strips similar to strips 470-1 through 470-N may be disposed on the back side of film 410. Alternatively, a single electrically continuous electrode can be disposed on the back side of film 410, for example covering the touch sensitive area of the touch sensor. For ease of illustration and without any loss of generality, FIG. 4 does not show any bottom conductive electrodes.

Referring back to FIG. 4, a touch implement 430 applies a touch to the touch sensor 400 at, for example, location Z4 along strip 470-2. In response to the applied touch, film 410 self-generates an electrical signal at Z4. The touch location Z4 is determined by detecting the self-generated signal at positions 450a-2 and 450b-2 along strip 470-2. In general, depending on the width of the strips 470-1 through 470-N, the separation between the strips, and the size of the touch implement, a self-generated signal may extend more than one strip in the y-direction. In such a case, for example, an interpolation algorithm may be used to determine the y-coordinate of the touch location by determining the strip that carries the largest signal. Alternatively, an algorithm similar to those used in Near Field Imaging (NFI) touch sensors may be used to determine the touch location in the y-direction. Examples of such algorithms are described in U.S. Pat. No. 5,650,597. Sensor 420, which generally includes electronics, and controller 480 determine the touch location Z4 and provide further appropriate response based on detectable signals detected at the two locations 440a-2 and 440b-2.

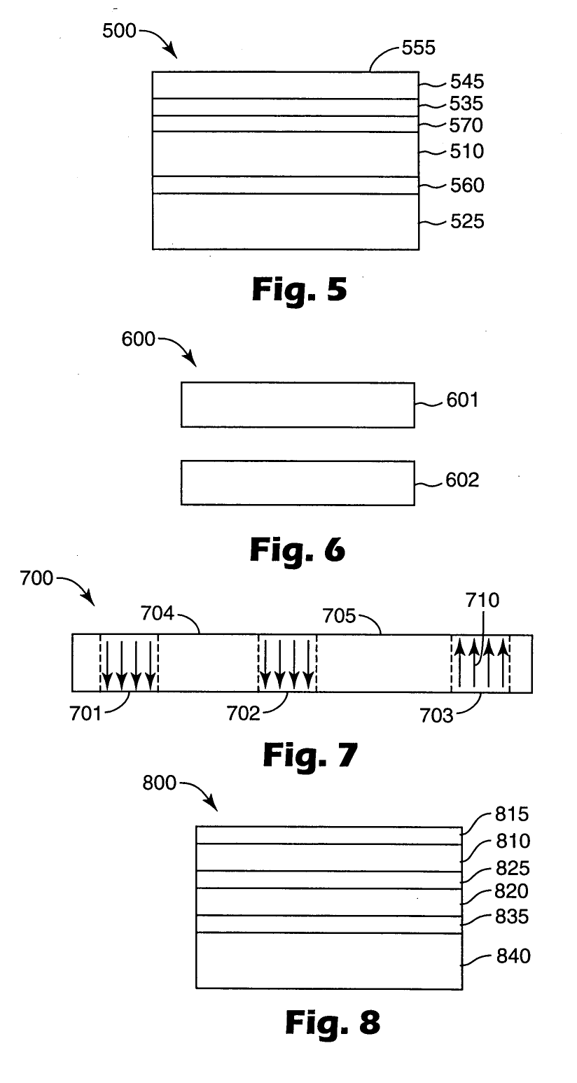

Referring back to FIG. 2, touch panel 290 may have additional layers. An exemplary construction is shown in FIG. 5. FIG. 5 shows a schematic side view of a touch sensor 500 in accordance with another aspect of the invention. Touch sensor 500 includes a film 510 having a property of self-generating a signal in response to a touch implement where the signal can be generated at the touch location. As discussed above, exemplary materials that can be incorporated in film 510 include piezoelectric and/or pyroelectric materials. Film 510 is disposed between a top electrically conductive layer 570 and a bottom electrically conductive layer 560. Optionally, film 510 may be in contact with either or both conductive layers. Protective layer 545 is disposed on the top electrode 570 and, in part, protects the sensor from damage such as scratching that may be caused by a touch implement or other factors. Adhesive layer 535 is disposed between protective layer 545 and electrode 570. Substrate 525, in part, provides support for the construction shown in FIG. 5. Electrodes 570 and 560 may be electrically discrete or continuous. Similarly film 510 can be discrete or continuous. For simplicity and without any loss of generality, sensor, controller, signal transmitters and other components necessary or desirable for detecting a touch location are not shown in FIG. 5.

Exemplary materials incorporated in adhesive layer 535 include UV curable adhesives, pressure sensitive adhesives, heat activated adhesives and thermoset adhesives.

Substrate 525 may be rigid or flexible. The substrate may be polymeric or any type of glass. For example, the substrate may be float glass, or it may be made of organic materials such as polycarbonate, acrylic, polyethylene terephthalate (PET), polyvinyl chloride (PVC), polysulfone, and the like. Alternatively, substrate 525 may include a metal, in which case, the substrate can also be used as the bottom electrode 560.

Surface 555 of the protective layer 545 may be matte to reduce glare. As discussed earlier, for ease of illustration and without any loss of generality FIG. 5 does not show a number of components in the touch sensor including the sensor, the controller and the electrical connections. Other exemplary layers that can be incorporated in touch sensor 500 and which are not explicitly shown in FIG. 5 include polarizers, retarders, color filters, anti-reflection coatings, graphics, electromagnetic interference (EMI) shields, electrostatic discharge (ESD) shields, anti-finger print coatings, and gaskets.

A touch panel according to the present invention can include two or more films that each have the property of self-generating a signal in response to a touch implement where the signal can be generated at the touch location. An exemplary construction is shown in FIG. 8, which shows a schematic side view of a touch panel 800 in accordance with one aspect of the invention. Touch sensor 800 includes a substrate 840, films 810 and 820 each having a property of self-generating a signal in response to a touch implement where the signal can be generated at the touch location, electrodes 815 and 835, and electrode containing layer 825.

As discussed above, exemplary materials that can be incorporated in films 810 and/or 820 include piezoelectric and/or pyroelectric materials. For example, both films 810 and 820 can be piezoelectric or both can be pyroelectric. As another example, one film can be piezoelectric and the other can be pyroelectric. For example, film 810 can be pyroelectric and film 820 can be piezoelectric. As shown, each of films 810 and 820 is disposed between two electrodes. For example, film 810 is disposed between electrode 815 and electrode containing layer 825, and film 820 is disposed between electrode containing layer 825 and electrode 835. Layer 825 can be constructed to be a single electrode that contacts both films 810 and 820, or can be constructed to include separate electrodes contacting each of films 810 and 820, the separate electrodes having an electrically insulating layer between them. Optionally, film 810 may be in contact with either or both electrodes 815 and 825, and film 820 may be in contact with either or both electrodes 825 and 835.

Although FIG. 8 shows two films 810 and 820 where each film has a property of self-generating a signal in response to a touch implement, it will be appreciated that touch panel 800 can have additional such films.

Piezoelectric films employed in the present invention can be manufactured in a number of ways. For example, a PVDF film may be produced by extruding PVDF pellets onto a chill roll, to produce an amorphous PVDF film, sometimes referred to as being in the alpha phase. Alternatively, a blend of PVDF and poly methyl methacrylate (PMMA) may be solvent coated to produce an amorphous coating. Next, the amorphous PVDF film is oriented by stretching the film in one or two directions. The stretching results in a semi-crystalline film sometimes referred to as the beta crystalline phase. Alternatively, the orientation may be achieved by compressing the amorphous film by, for example, feeding the film through rollers having a pre-determined gap. For some film compositions the orientation step may not be necessary.

Next, the PVDF film can be poled by placing the film in an electric filed, for example, by placing the film between two charged parallel plates. The poling field is typically 50 to 100 volts per micron at a temperature of about 80 to 120 degrees Centigrade, although the poling may be achieved at other temperatures. The poling process usually takes approximately 30 minutes, after which the film is cooled to room temperature in the presence of the poling electric field. Alternatively, the film may be poled by corona discharge, at a similar temperature range, but usually for a shorter time. In some cases the poling may be done with electrodes already in place on the film. Typically, in a corona process, the film need not be in intimate contact with an electrode because the corona typically develops a charge distribution on the surface of the film. For some material compositions, it may be possible to pole an amorphous film without first orienting the film. Alternatively, for some compositions or under certain conditions, the steps of orienting and poling the film, may be done at the same time. U.S. Pat. Nos. 4,606,871, 4,615,848, and 4,820,586 further describe the process of poling a piezoelectric film. It will be appreciated that according to the present invention the film can be made to be continuously piezoelectric or piezoelectric only in pre-determined regions. This can be achieved, for example, by poling the film at pre-determined areas as illustrated in FIG. 7.

FIG. 7 illustrates a schematic side-view of a piezoelectric film 700 in accordance with one aspect of the invention. Film 700, according to one aspect of the invention, is used in a system where a location of an applied external agent, such as a touch implement, is determined by detecting a signal, for example an electrical signal, self-generated by film 700 in response to the external agent, at a plurality of positions on the film. Film 700 is processed in such a way that the film has a piezoelectric property in areas 701, 702, and 703, but not in areas 704 and 705. The arrows symbolically indicate that the film has been poled and is piezoelectric in regions where the arrows are located. The poling direction may be different in various locations of film 700 where the film is piezoelectric. For example, in FIG. 7, the poling direction in area 703 is opposite to the poling direction in areas 701 and 702. The poling direction can provide further information regarding the self-generated signal including its location. An advantage of a touch sensor in which the touch sensing film is piezoelectric only at pre-determined areas is that no signal is self-generated and therefore, no touch is sensed in areas where the film is not piezoelectric. Accordingly, the need for software and electronics to reject a touch applied to impermissible locations may be reduced or eliminated. As an exemplary application, the areas of the film located under the bezel in a touch sensor can be non-piezoelectric so that inadvertent bezel forces are not registered as a valid touch.

Referring back to FIG. 8, in the case where films 810 and 820 are both piezoelectric, the films can be poled in the same direction or in opposite directions. In general, where touch panel 800 includes multiple piezoelectric films, the films can all be poled in the same direction or in different directions. For example, alternating piezoelectric films can be poled in opposite directions.

FIG. 6 illustrates a schematic cross-section of a display system 600 in accordance with one aspect of the present invention. Display system 600 includes a touch sensor 601 and a display 602. Touch sensor 601 can be a touch sensor according to any embodiment of the present invention. Display 602 can include permanent or replaceable graphics (for example, pictures, maps, icons, and the like) as well as electronic displays such as liquid crystal displays (LCD), cathode ray tubes (CRT), plasma displays, electroluminescent displays, organic electroluminescent displays, organic light emitting displays (OLED), electrophoretic displays, and the like. It will be appreciated that although in FIG. 6 display 602 and touch sensor 601 are shown as two separate components, the two can be integrated into a single unit. For example, touch sensor 601 can be laminated to display 602. Alternatively, touch sensor 601 can be an integral part of display 602.

Although the embodiments disclosed in the present invention display a single layer film that has the property of self-generating a signal in response to an external agent applied to a location on the film, it will be appreciated that each embodiment can include two or more layers where each layer has the property of self-generating a signal in response to an external agent. Furthermore, it will be appreciated that a system, such as a touch sensor, according to the present invention, has high optical transmission, can be stylus independent and can be designed to have no moving parts. Furthermore, a system, such as a touch sensor, according to the present invention, can be integrated into other systems such as a display system. It will also be appreciated that according to the invention a physical contact between a touch implement and the film capable of self-generating a signal is not necessarily required to register a touch.

All patents, patent applications, and other publications cited above are incorporated by reference into this document as if reproduced in full. While specific examples of the invention are described in detail above to facilitate explanation of various aspects of the invention, it should be understood that the intention is not to limit the invention to the specifics of the examples. Rather, the intention is to cover all modifications, embodiments, and alternatives falling within the spirit and scope of the invention as defined by the appended claims.

What is claimed is:

1. A system comprising:
a film that self-generates an electrical signal in response to an external agent applied to a location on the film; and
a sensor configured to detect the electrical signal at a plurality of positions on the film to determine the location where the external agent is applied to the film.

2. The system according to claim 1 further comprising a controller coupled to the sensor and adapted to determine the location where the external agent is applied to the film.

3. The system according to claim 1 wherein the external agent comprises a touch implement.

4. The system according to claim 1 wherein the self-generated electrical signal is generated at the location where the external agent is applied to the film.

5. The system according to claim 1 wherein the film is piezoelectric.

6. The system according to claim 1 wherein the film is pyroelectric.

7. The system according to claim 1 employed in a touch sensor to detect a location of an applied touch.

8. The system according to claim 1 being optically transmissive.

9. The system according to claim 1 being optically opaque.

10. The system according to claim 1 wherein the self-generated signal is an electric current.

11. The system according to claim 1 wherein the self-generated signal is a voltage.

12. The system according to claim 1 further comprising one or more electrically continuous electrodes disposed on at least one side of the film.

13. A system comprising:
a film that self-generates an electrical signal in response to an external agent applied to a location on the film, the self-generated electrical signal producing at least a first detectable signal at a first position on the film and a second detectable signal at a second position on the film; and
a controller adapted to receive at least the first and second detectable signals to determine the location where the external agent is applied to the film.

14. The system according to claim 13 further comprising a sensor coupled to the film and the controller and configured to detect at least the first and second detectable signals and transmit the detected signals to the controller.

15. A touch sensor comprising:
a film that self-generates an electrical signal in response to a touch implement applied to a location on the film, the touch location being determined by detecting the electrical signal at a plurality of positions on the film.

16. The touch sensor according to claim 15 wherein the film is piezoelectric.

17. The touch sensor according to claim 15 wherein the film is pyroelectric.

18. The touch sensor according to claim 15 wherein the film is piezoelectric only in pre-determined regions.

19. The touch sensor according to claim 15 wherein the film is pyroelectric only in pre-determined regions.

20. The touch sensor according to claim 15 being optically transmissive.

21. The touch sensor according to claim 15 wherein the touch location is determined by detecting the electrical signal at two locations on the film.

22. The touch sensor according to claim 15 wherein the touch location is determined by detecting the electrical signal at four locations on the film.

23. The touch sensor according to claim 15 being rigid.

24. The touch sensor according to claim 15 being flexible.

25. The touch sensor according to claim 15 being combined with a display.

26. The touch sensor according to claim 15 further comprising one or more electrically continuous electrodes disposed on at least one side of the film.

27. The touch sensor according to claim 26 wherein the electrically continuous electrodes are uniform to within 10%.

28. The touch sensor according to claim 26 wherein the electrically continuous electrodes are uniform to within 2%.

29. The touch sensor according to claim 26 wherein the electrically continuous electrodes are uniform to within 0.5%.

30. The touch sensor according to claim 15 further comprising at least one additional film where each additional film has the property of self-generating a signal in response to the touch implement where the signal generated by each additional film can be generated at the touch location.

31. The touch sensor according to claim 26 wherein the continuous electrodes are optically transmissive.

32. The touch sensor according to claim 26 wherein the continuous electrodes comprise indium tin oxide.

33. The touch sensor according to claim 26 wherein the continuous electrodes comprise an optically transmissive conductive polymer.

34. A touch sensor comprising:
a film that self-generates an electrical signal in response to a touch implement applied to a location on the film, the touch location being determined by at least a first sensor detecting a first detectable signal produced by the self-generated electrical signal at a first position on the film and a second sensor detecting a second detectable signal produced by the self-generated electrical signal at a second position on the film.

35. A method of determining a touch location comprising the steps of:
defining a touch sensitive area comprising a film that self-generates an electrical signal in response to an applied touch input;
detecting a plurality of detectable signals produced in response to the self-generated electrical signal; and
using the plurality of detectable signals to determine the touch location.
